(19) United States
(12) Patent Application Publication
(10) Pub. No.: US 2006/0227363 A1
(43) Pub. Date: Oct. 12, 2006

(54) Apparatus and method for managing print jobs among a plurality of printers

(75) Inventor: Kaori Ogura, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/091,446

(22) Filed: Mar. 29, 2005

(51) Int. Cl. G06F 3/12

(52) U.S. Cl. 358/1.15; 358/402

(57) ABSTRACT

An apparatus and method for printing a print job includes receiving a request to print a print job at a destination printer, determining a status of the destination printer, and sending the print job to the destination printer only if the status indicates that the destination printer is not busy. In addition, a status is determined of each of one or more substitute printers, and the print job is sent to one of the one or more substitute printers whose status is not indicated to be busy if the status of the destination printer is indicated to be busy.

### FIELD OF THE INVENTION

The present invention relates generally to print job management and, more particularly, to a system and method for managing print jobs among a plurality of printers.

### BACKGROUND OF THE INVENTION

In a networked system, a user may submit a print job to any one of a plurality of printers or multi-function peripherals/printers (MFPs) that are in the network. A printer can be considered a device whose only function is to print documents, an MFP that performs multiple functions including printing, or any other device that is capable of printing a document in response to a print request. Typically, a user is assigned a printer to which the print job is sent by default. However, the user can change the assigned printer or can select a different printer for a particular print job.

If there are other print jobs being processed by the printer receiving the print job submitted by the user, the submitted print job is placed in a queue. Typically, the submitted print job will be printed only after the already submitted print jobs are completed. As a result, if there are many pending print jobs, an earlier submitted print job is very large, or the destination printer otherwise has some problem associated with it, then the user may have to wait a significant amount of time before the user's print job is completed.

Some conventional network systems provide a tandem printing system. In such a system, a special connection is provided between two printers. When one of the printers receives a print job, it checks its status and, if it is busy, sends the print job to the other one of the printers. For example, if a user sends a print job to printer A, then printer A prints the print job if printer A is not busy. However, if printer A is busy, then printer A transfers the job to printer B, i.e., the tandem printer. The same processing applies to print jobs sent by the user to printer B. To enable the tandem printing system, each printer requires customized programming and a particular communication connection between the two printers.

In other conventional systems, a printer checks its status in response to receiving a print job. If the printer determines that it is busy, it searches for any other printer to perform the print job and sends it to the other printer. Alternatively, if the printer determines that it is busy, then the printer sends a message to the user submitting the print job that the printer is busy. In such systems, the checking is done after the printer has received the print job.

### SUMMARY OF THE INVENTION

According to an aspect of the invention, an image forming apparatus and method for printing a print job includes receiving a request to print a print job at a destination printer, determining a status of the destination printer, and sending the print job to the destination printer only if the status indicates that the destination printer is not busy. In addition, a status is determined of each of one or more substitute printers, and the print job is sent to one of the one or more substitute printers whose status is not indicated to be busy if the status of the destination printer is indicated to be busy.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a network including a plurality of printers consistent with the present invention.

FIG. 2 is a flow diagram of print job management process using a print job management application implemented on a user computer or a server consistent with the present invention.

FIG. 3 is a flow diagram of a print job management process for determining printer status consistent with the present invention.

FIG. 4 is a flow diagram of a print job management process for identifying and selecting substitute printers consistent with the present invention.

### DETAILED DESCRIPTION OF PREFERRED EMBODIMENTS

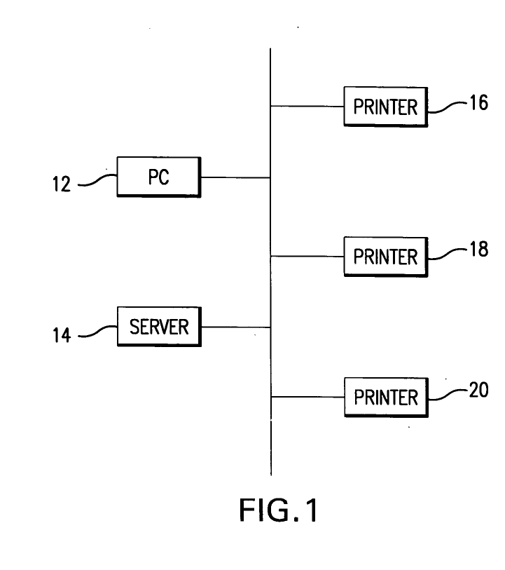

FIG. 1 is a block diagram of a network including a plurality of printers consistent with the present invention. As shown in FIG. 1, the network includes a personal computer (PC) 12, a server 14, a destination printer 16, a first substitute printer 18, and a second substitute printer 20. Each of these components may be coupled together by a network connection or by a direct communication connection. The network connection may be implemented by a local network, such as a LAN, or a public network, such as the Internet.

The PC 12 may be a workstation, desktop or laptop computer, a mobile phone, a PDA, a magnetic card, or some combination thereof, or any other computing structure. The PC 12 preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the PC 12 provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

If the network connection is an Internet connection, the PC 12 can transmit a requested code for an application program through the Internet, an ISP, the local network and the communication interface. The received code can be executed by the CPU in the PC 12 as it is received, stored in the storage device, or stored in some other non-volatile storage for later execution. In this manner, the PC 12 may obtain application code in the form of a carrier wave. Although only one PC 12 is shown, it should be understood that the network may have two or more PCs coupled to the network. The server 14 may be implemented in the same manner as the PC 12, plus any other functionality that may be needed to manage the operation of the network.

The printers 16, 18, 20 are devices capable of printing a document or file. The printers 16, 18, 20 may be color or black and white, laser or ink jet or other printing type, and capable of performing functions other than printing. Devices capable of performing additional functions beyond printing, such as copying, faxing, scanning and acting as a file server, are referred to as multi-function peripherals or printers (MFPs). For the purposes of this application, reference to printers 16, 18, 20 includes MFPs. Although FIG. 1 shows three printers 16, 18, 20, the network may be coupled to more than three printers or only two printers.

In this embodiment, the printer 16 is referred to as a destination printer in that it is the default printer to which a print job is sent. The printers 18, 20 are referred to as substitute printers that may be used to process a print job if the destination printer 16 is busy. The designation of each printer as a destination printer or a substitute printer is only exemplary, and is meant to assist in the explanation of the print management process described herein. Further, it should be understood that the destination printer can be changed.

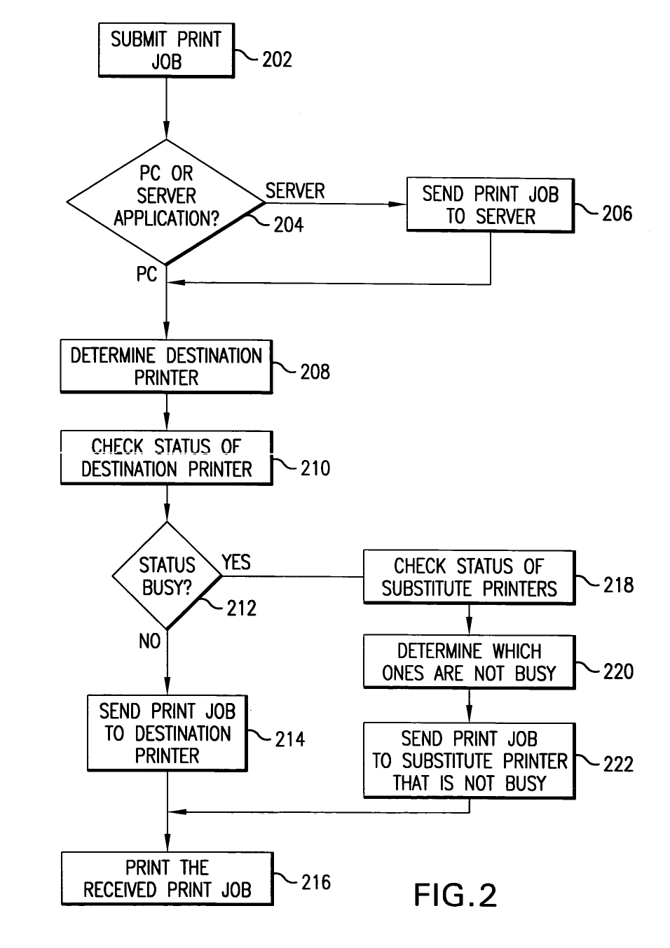

FIG. 2 is a flow diagram of print job management process using a print job management application implemented on a user computer or a server consistent with the present invention. As shown in FIG. 2, a print job is submitted (step 202). A print job includes, for example, a request from a user at PC 12 to print a document or file. A print job may also include any function or operation that results in a request to print or reproduce a document or file. For example, after a fax is received, the fax is printed. The printing of the fax corresponds to a print job. Further, copying a document includes scanning the document, performing image processing on the scanned data, and then printing the image processed data. The printing of the image processed data can also be considered a print job. The contents of the print job include the data to be printed and information identifying which printer has been designated to print the data. Unless the user manually designates which printer to print the data, the print job will identify the default printer, i.e., the destination printer 16, as the printer designated to print the data.

Before sending the print job to the destination printer, a determination is made as to whether a print management application is present in the PC 12 or the server 14 (step 204). The print management application is an application that manages where the submitted print job is printed. The print management application is preferably implemented in software, although it can alternatively be implemented in hardware or some combination of software and hardware. Further, the print management application can be implemented as a plug-in application in the PC 12 or the server 14. It is also possible for the print management application to be distributed across multiple devices, such as partly on the PC 12 and partly on the server 14. If there is no print management application present on the PC 12, then the print job is sent to the server 14 having a print management application (step 206). It should be understood that the print management application can be located on each PC 12 coupled to the network, the server 14, and/or any other device on the network that may generate or handle a print request, such as a fax machine or a copying machine.

The print management application on the PC 12 or server 14 determines which printer is the destination printer from the print job (step 208). For purposes of the following explanation, the destination printer is assumed to be the destination printer 16 shown in FIG. 1. As described previously, the print job includes information identifying the destination printer. The print management application checks the status of the determined destination printer (step 210). In addition, based on a check of the status, the print management application determines whether the destination printer is busy or not (step 212).

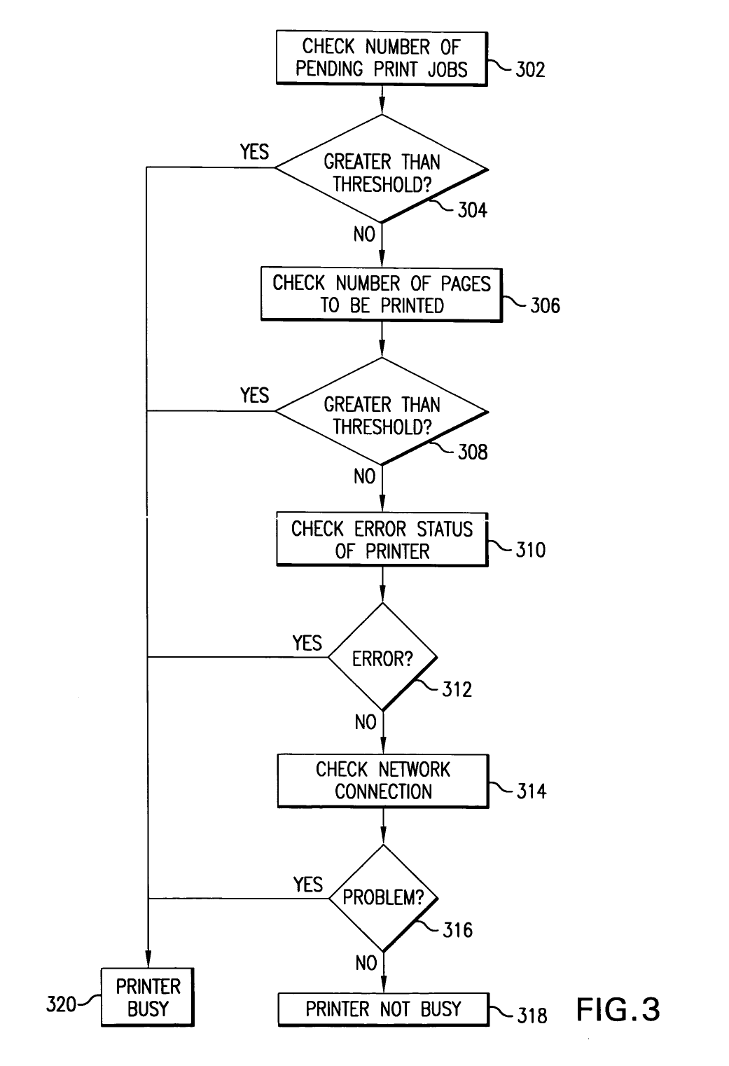

The process of checking whether a printer is busy is further explained with reference to FIG. 3, which is a flow diagram of a print job management process for determining printer status consistent with the present invention. This process for determining whether a printer is busy may be applied to any printer coupled to the network, and not just the destination printer 16.

As shown in FIG. 3, the print management application checks the number of pending print jobs at the printer (step 302). Typically, each printer has a queue that holds each print job waiting to be printed on the printer. To obtain the information about the number of print jobs pending in the printer, the print management application may communicate with the printer using the Simple Network Managing Protocol (SNMP) and a Management Information Base (MIB). In general, printers have a standardized MIB, which includes information about the operation and status of the printer, including the number of pending print jobs. It is also possible to have a customized or private MIB having a greater amount of information available about the printer than the standard MIB, such as information about finishing options (e.g., stapling, hole punch, etc.) available on the printer. The MIB is communicated to the print management application using the SNMP.

The number of pending print jobs is compared against a threshold (step 304). The threshold can be a predetermined value, such as five print jobs, or can be a settable value that allows a user or network administrator to set the threshold. If the number of pending print jobs is greater than the threshold, then the printer is identified as being busy (step 320). If the printer is identified as being busy, then the evaluation in step 212 of FIG. 2 can be determined.

If the number of pending print jobs is less than or equal to the threshold, then the print management application checks the number of pages to be printed by the pending print jobs (step 306). Although this check is performed if the number of pending print jobs is less than or equal to the threshold, it should be understood that if the number is equal to the threshold, the printer can be identified as busy. In other words, when checking against a threshold, if the value is equal to the threshold, then the printer may be identified as busy or not busy, depending upon the desired determination. The determination of the number of pages to be printed can be determined in the same manner as the determination of the number of pending print jobs. In other words, the print management application can determine the number of pages to be printed from the MIB received from the printer, or using any other system for communicating such information from the printer to the print management application.

Like the number of pending print jobs, the number of pages to be printed is compared to a threshold (step 308). The threshold can be a predetermined value, such as 100 pages, or can be a settable value that allows a user or network administrator to set the threshold. If the number of pages to be printed is greater than the threshold, then the printer is identified as being busy (step 320). If the printer is identified as being busy, then the evaluation in step 212 of FIG. 2 can be determined.

If the number of pending print jobs and pages to be printed are both less than or equal to their respective thresholds, the print management application checks an error status of the printer (step 310). The printer may have an error status if, for example, there is a paper jam, there is no paper in the printer, the toner is empty, or any other condition that renders the printer inoperable until remedied. The error status information can be communicated to the print management application in the same manner as the number of pending print jobs and number of pages to be printed. Based on the checked error status, the print management application determines whether or not there is a printer error (step 312). If there is an error, then the printer is identified as being busy (step 320). If the printer is identified as being busy, then the evaluation in step 212 of FIG. 2 is deemed completed.

If there is no error status, then the print management application checks if there is a problem with the network connection to the printer (step 314). There may be a problem with the network connection, for example, if there is heavy traffic on the network, if there is a problem with the communication of the printer with the network, or there is any other problem that would make it difficult or impossible for the print job to be communicated to the printer. To detect a problem with the network connection, the print management may communicate with a network management application operating on the server 14. The network management application is preferably configured to monitor the network connection status of each device on the network. The network connection status information can be communicated to the print management application using SNMP.

If there is a problem with the network connection of the printer, then the printer is identified as being busy (step 320). If the printer is identified as being busy, then the evaluation in step 212 of FIG. 2 is deemed completed. However, if there is no problem with the network connection, then the printer is identified as being not busy (step 318). If the printer is identified as being not busy, then the evaluation in step 212 of FIG. 2 can be determined.

In the process of FIG. 3 for determining whether or not a printer is busy, several different conditions are evaluated independently to make the busy or not busy determination. It is possible, however, for the conditions to be evaluated in combination. For example, even if the number of pending print jobs exceeds a threshold, the printer can be determined to be busy only if the number of pages to be printed also exceeds a threshold. Further, these thresholds could be adjustable depending upon the value of the other. For example, the thresholds could be five jobs and 100 pages, or ten jobs and fifty pages, i.e., if the number of pending print jobs is over five, then the printer is busy if the number of pages to printed is over 100, and if the number of pending print jobs is over ten, then the printer is busy if the number of pages to be printed is over 50. Further, other factors may be considered, such as the image file size of the document being printed (e.g., large PDF files as opposed to word processing files).

Returning to FIG. 2, based on the processing of FIG. 3, the print management application determines if the destination printer 16 is busy and, if not, sends the print job to the destination printer 16 (step 214). The destination printer 16 receives the print job and prints it (step 216). If there are print jobs pending at the destination printer 16, then the received print job is printed after the pending print jobs are completed.

If, on the other hand, the destination printer 16 is identified as being busy at step 212, then the print management application checks the status of the substitute printers (step 218). The substitute printers include at least the substitute printers 18, 20 shown in FIG. 1. The substitute printers may include more than just the two substitute printers 18, 20 shown in FIG. 1. To check the status of each substitute printer, the print management application may apply the process of FIG. 3, as described above, or any other algorithm.

From the check of the status of each of the substitute printers, the print management application determines which ones of the substitute printers are not busy (step 220). For example, substitute printer 18 may be busy, while substitute printer 20 is not busy. In accordance with the determination of the substitute printers that are not busy, the print management application identifies one of the substitute printers that is not busy and sends the print job to that substitute printer (step 222). Accordingly, since substitute printer 20 is not busy, and substitute printer 18 is busy, the print management application sends the print job to substitute printer 20. The substitute printer receives the print job and prints it (step 216). If there are pending print jobs on the substitute printer, then the received is printed after the pending print jobs are completed.

In the process of FIG. 2, if the destination printer is busy, one or more substitute printers can be identified to perform the print job. Further, the print job can be sent to an identified substitute printer automatically, i.e., without approval from the user submitting the print job, or the user can first be prompted to approve the transfer of the print job to a substitute printer. For example, a window may be shown on the PC 12 through which the user submitted the print job asking the user to approve the transfer to the substitute printer or listing the available substitute printers so that the user can select the substitute printer to receive and print the print job.

Even if the destination printer is busy, the user may still have the option to send the print job to the destination printer, regardless of whether any substitute printers are available. For example, if the available substitute printers are not located in a position convenient to the physical location of the user, the user may prefer to have the print job printed at the busy destination printer anyway. The user may also elect to cancel the print job in the event that the destination printer is busy. The same window showing the user which substitute printers are available can include options for the user to elect to print at the busy destination printer or to cancel the print job.

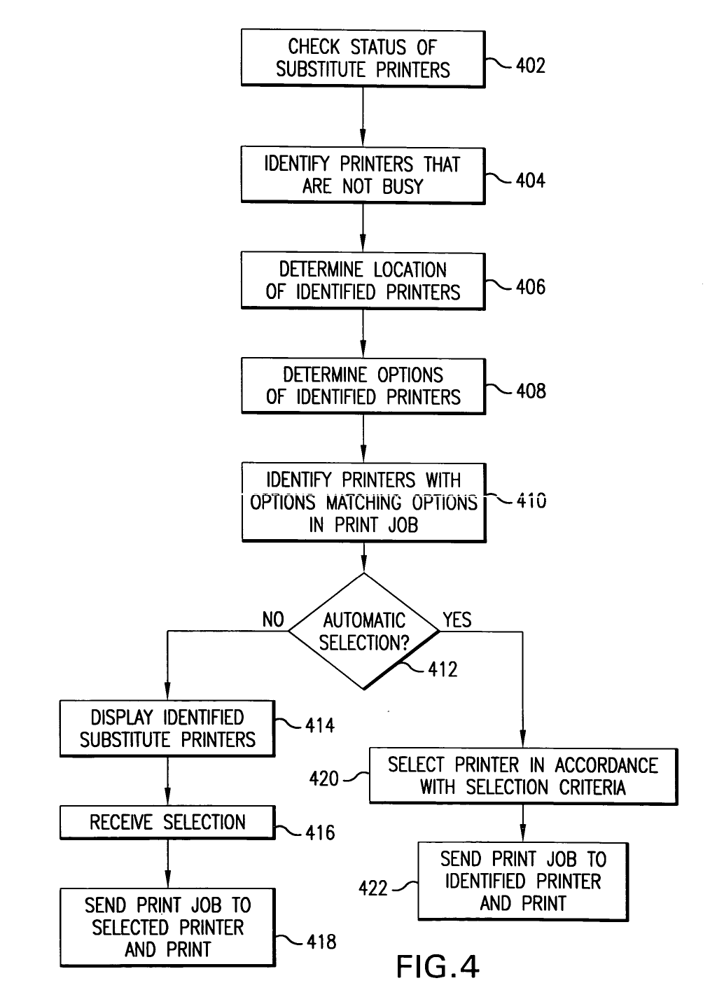

In addition to the status of the substitute printers, other criteria can be used to determine to which substitute printer to send the print job if the destination printer is busy. FIG. 4 is a flow diagram of a print job management process for identifying and selecting substitute printers consistent with the present invention.

As shown in FIG. 4, similar to FIG. 2, the status of each of the substitute printers is checked (step 402), and each substitute printer that is not busy is identified (step 404). The substitute printers identified as being not busy may be all of the substitute printers in the network (e.g., substitute printers 18 and 20), a subset of the substitute printers in the network (e.g., substitute printer 20 only), or none of the substitute printers. In the event that none of the substitute printers are available, the print job may still be sent to the destination printer 16 even though it is busy. Alternatively, the print management application can send a message to the user submitting the print job that all printers are busy and request that the user resubmit the print job later or select a printer to print the print job anyway.

In addition to determining or identifying which substitute printers are not busy, the print management application determines a location of each of the identified substitute printers (step 406). The determination of the location may be made for only those substitute printers that are not busy or may be made for all available substitute printers. The location of a substitute printer may be determined from the MIB provided by the substitute printer to the print management application using SNMP.

The print management application also determines the printing options available on the substitute printers (step 408). The determination of the printing options may similarly be made for only those substitute printers that are not busy or may be made for all available substitute printers. The printing options include, for example, color or black and white (B/W), available finishing options, printing speed, laser or ink jet, or any other option that can be used to control the manner in which the printer prints the print job.

Based on the determined printing options, the print management application identifies which substitute printers have printing options matching the printing options set in the print job (step 410). For example, if the print job is set to print in color and to staple the printed document, the print management application identifies which substitute printers are capable of color printing and stapling the printed document. If a substitute printer does not have the capability to perform the printing options set in the print job, the print management application can determine or identify which of the print options is not present in the substitute printer and inform the user accordingly.

The print management application determines whether the substitute printer is selected automatically (step 412). This determination can be based on a setting of the print management application. The default setting may be, for example, that the user selects which substitute printer to use. The setting may also be changed by the user or by a network administrator to allow for automatic selection, described herein.

If it is not selected automatically, then a display of the substitute printers is provided to the user that submitted the print job (step 414). The display may be a pop-up window on the PC 12 or a display on a device used to submit the print job. Another option is some form or type of display on the destination printer. The display may show all of the available substitute printers, along with each printer's status (busy or not busy), location, and ability to perform the printing options set in the print job. Alternatively, the display may be limited to the substitute printers that are not busy and capable of performing the printing options set in the print job. If no other printer has the ability to perform the set printing options, the user can be given the chance to use the destination printer or the substitute printer with the closest options. It is also possible for the list to be further limited to substitute printers located within a predetermined distance of the location at which the print job was submitted.

A user selects one of the substitute printers from the displayed list (or keeps the original destination printer), and the selection is received by the print management application (step 416). To make the selection, the user may use, for example, a pointing device, such as a mouse or touch pad, a keyboard or a touch screen. The print management application sends the print job to the selected substitute printer, which prints the received print job (step 418).

If, however, the substitute printer is to be selected automatically, then the substitute printer is selected in accordance with selection criteria (step 420). The selection criteria can be based on the status, location, or printing option capabilities of the substitute printers, or some combination thereof. For example, the selection criteria may include selecting the substitute printer that is not busy, is capable of performing the printing options set in the print job, and is closest to the location at which the print job was submitted. The actual selection criteria used may have default settings and may be changed by the user or the network administrator.

If none of the substitute printers satisfies the criteria, such as if none of the substitute printers is capable of performing all of the printing options set in the print job, then the user may be provided with a display of the substitute printers as described above with respect to step 414 to select which one to use, or the print management application may be configured to select the substitute printer that most closely matches the selection criteria. It is also possible that if none of the substitute printers satisfies the criteria, the user may have the option to send the print job to the busy destination printer anyway or to cancel the print job. Similarly, the print management application may be configured to send the print job to the busy destination printer or to cancel the print job if none of the substitute printers satisfies the criteria.

Based on the selection, the print management application sends the print job to the selected substitute printer (step 422). The selected printer receives the print job and prints it.

As described above, it is possible for an alternative or substitute printer to process and print a submitted print job if the original or destination printer is busy. Further, the identification of a substitute printer to print the print job can be achieved before sending the print job to the destination printer. In other words, before sending the print job, a check is made to determine if the destination printer is busy and, if it is busy, the system sends the print job to a substitute printer. As a result, it is possible to avoid the delay arising from sending the printing job to a destination printer that is busy.

As also described above, a substitute printer can be used to print the print job if the destination printer is busy for any of a number of reasons, such as a large number of pending print jobs or pages to be printed, an error at the destination printer, or a network connection problem. In addition, a substitute printer can be selected automatically in accordance with various criteria including printer status, location, and printing capabilities. Alternatively, a user can be prompted to select the substitute printer, but with the status, location, and printing capability information provided to the user, which allows the user to make an informed decision as to which substitute printer to use.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for printing a print job, comprising:
receiving a request to print a print job at a destination printer;
determining a status of the destination printer;
sending the print job to the destination printer only if the status indicates that the destination printer is not busy;
determining a status of each of one or more substitute printers;
sending the print job to one of the one or more substitute printers whose status is not indicated to be busy if the status of the destination printer is indicated to be busy.

2. A method according to claim 1, further comprising:
identifying each of the one or more substitute printers whose status is not busy; and
displaying a list of the identified substitute printers for a user submitting the print job.

3. A method according to claim 2, further comprising:
receiving an input selecting one of the identified substitute printers; and
sending the print job to the selected substitute printer.

4. A method according to claim 2, wherein the list includes information identifying at least one of a physical location of the identified substitute printers and printing option capabilities of the identified substitute printers.

5. A method according to claim 1, wherein the status of a printer is indicated to be busy if at least one of a number of print jobs pending exceeds a threshold and a number of pages to be printed from pending print jobs exceeds a threshold.

6. A method according to claim 1, wherein the status of a printer is indicated to be busy if the printer determined to be inoperable.

7. A method according to claim 8, wherein the inoperable determination is based on any one of a paper jam condition, a paper empty condition, and a toner empty condition.

8. A method according to claim 1, further comprising:
detecting printing options set in the print job;
identifying which of the substitute printers is capable of performing the printing options set in the print job; and
sending the print job to one of the substitute printers identified as being capable of performing the printing options set in the print job.

9. A method according to claim 1, further comprising:
identifying which substitute printer is closest in location to a physical location where the print job was submitted; and
sending the print job to the substitute printer identified as being closest in location to the physical location where the print job was submitted.

10. A method according to claim 1, wherein the print job is sent to one of the one or more substitute printers without being sent to the destination printer.

11. A method according to claim 1, further comprising:
automatically selecting one of the one or more substitute printers whose status is not indicated to be busy; and
sending the print job to the selected substitute printer.

12. A method according to claim 11, further comprising:
displaying a location of where the print job was printed to a user submitting the print job.

13. A computer system for printing a print job, comprising:
a processor,
a memory, coupled to the processor, the memory comprising a plurality of instructions executed by the processor, the plurality of instructions configured to:
receive a request to print a print job at a destination printer;
determine a status of the destination printer;
send the print job to the destination printer only if the status indicates that the destination printer is not busy;
determine a status of each of one or more substitute printers;
send the print job to one of the one or more substitute printers whose status is not indicated to be busy if the status of the destination printer is indicated to be busy.

14. A computer readable medium operable on a computer system configured to print a print job, the computer readable medium configured to:
receive a request to print a print job at a destination printer;
determine a status of the destination printer;
send the print job to the destination printer only if the status indicates that the destination printer is not busy;
determine a status of each of one or more substitute printers;
send the print job to one of the one or more substitute printers whose status is not indicated to be busy if the status of the destination printer is indicated to be busy.

15. A method for printing a print job, comprising:
receiving a request to print a print job at a destination printer;
determining a status of the destination printer;
sending the print job to the destination printer only if the status indicates that the destination printer is not busy;
identifying one or more substitute printers for printing the print job in place of the destination printer;
sending the print job to the destination printer whose status is indicated to be busy in response to a first indication; and
sending the print job to one of the one or more substitute printers in response to a second indication different from the first indication.

16. A method according to claim 15, further comprising:
canceling the print job in response to a third indication different from the first and second received indications.

17. A method according to claim 16, further comprising receiving the first indication in response to a user request to send the print job to the destination printer whose status is indicated to be busy;
receiving the second indication in response to a user request to send the print job to one of the one or more substitute printers; and
receiving the third indication in response to a user request to cancel the print job.

18. A method according to claim 16, wherein the third indication is received if the destination printer and each of the one or more substitute printers has a status indicated to be busy, is not capable of performing printing options set in the print job, or both.

19. A method according to claim 15, further comprising:
determining a status of each of the one or more substitute printers; and
sending the print job to one of the one or more substitute printers whose status is not indicated to be busy in response to the second indication.

20. A method according to claim 15, further comprising
detecting printing options set in the print job;
identifying which of the substitute printers is capable of performing the printing options set in the print job; and
sending the print job to one of the substitute printers identified as being capable of performing the printing options set in the print job in response to the second indication.
